(19) United States
(12) Patent Application Publication
(10) Pub. No.: US 2025/0016719 A1
(43) Pub. Date: Jan. 9, 2025

(54) RADIO FREQUENCY SENSING USING POSITIONING REFERENCE SIGNALS (PRS)

(71) Applicant: QUALCOMM INCORPORATED, San Diego, CA (US)

(72) Inventors: Weimin DUAN, San Diego, CA (US); Alexandros MANOLAKOS, Athens (GR); Sven FISCHER, Nuremberg (DE)

(21) Appl. No.: 18/707,726

(22) PCT Filed: Dec. 22, 2022
(86) PCT No.: PCT/US2022/082215

§ 371 Date: May 6, 2024

(30) Foreign Application Priority Data
Jan. 24, 2022 (GR) 20220100063

(51) Int. Cl. H04W 64/00; H04L 5/00; H04W 24/10

(52) U.S. Cl. CPC H04W 64/00; H04L 5/0051; H04W 24/10

(57) ABSTRACT

A radio frequency sensing method includes: receiving, at a sensing apparatus from a network entity, a configuration message indicating a positioning reference signal configuration of a positioning reference signal; receiving, at the sensing apparatus from the network entity, a measurement indication indicating that the positioning reference signal is for radio frequency sensing; and measuring, at the sensing apparatus, the positioning reference signal to determine one or indicating a positioning reference signal more radio frequency sensing measurements based on the measurement indication indicating that the positioning reference signal is for radio frequency sensing.

### CROSS-REFERENCE TO RELATED APPLICATIONS

This application claims the benefit of Greek Patent Application Ser. No. 20220100063, filed Jan. 24, 2022, entitled “RADIO FREQUENCY SENSING,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example sensing apparatus includes: a memory; a transceiver; and a processor, communicatively coupled to the memory and the transceiver, configured to: receive, via the transceiver from a network entity, a configuration message indicating a positioning reference signal configuration of a positioning reference signal; receive, via the transceiver from the network entity, a measurement indication indicating that the positioning reference signal is for radio frequency sensing; and measure the positioning reference signal to determine one or more radio frequency sensing measurements based on the measurement indication indicating that the positioning reference signal is for radio frequency sensing.

An example radio frequency sensing method includes: receiving, at a sensing apparatus from a network entity, a configuration message indicating a positioning reference signal configuration of a positioning reference signal; receiving, at the sensing apparatus from the network entity, a measurement indication indicating that the positioning reference signal is for radio frequency sensing; and measuring, at the sensing apparatus, the positioning reference signal to determine one or more radio frequency sensing measurements based on the measurement indication indicating that the positioning reference signal is for radio frequency sensing.

Another example sensing apparatus includes: means for receiving, from a network entity, a configuration message indicating a positioning reference signal configuration of a positioning reference signal; means for receiving, from the network entity, a measurement indication indicating that the positioning reference signal is for radio frequency sensing; and means for measuring the positioning reference signal to determine one or more radio frequency sensing measurements based on the measurement indication indicating that the positioning reference signal is for radio frequency sensing.

An example non-transitory, processor-readable storage medium includes processor-readable instructions to cause a processor of a sensing apparatus to: receive, from a network entity, a configuration message indicating a positioning reference signal configuration of a positioning reference signal; receive, from the network entity, a measurement indication indicating that the positioning reference signal is for radio frequency sensing; and measure the positioning reference signal to determine one or more radio frequency sensing measurements based on the measurement indication indicating that the positioning reference signal is for radio frequency sensing.

An example network entity includes: a memory; a transceiver; and a processor, communicatively coupled to the memory and the transceiver, configured to: schedule, for a sensing apparatus, a positioning reference signal configuration of a positioning reference signal; and indicate, to the sensing apparatus, that the positioning reference signal is for radio frequency sensing.

An example positioning reference signal scheduling method includes: scheduling, by a network entity for a sensing apparatus, a positioning reference signal configuration of a positioning reference signal; and indicating, from the network entity to the sensing apparatus, that the positioning reference signal is for radio frequency sensing.

Another example network entity includes: means for scheduling, for a sensing apparatus, a positioning reference signal configuration of a positioning reference signal; and means for indicating, to the sensing apparatus, that the positioning reference signal is for radio frequency sensing.

Another non-transitory, processor-readable storage medium includes processor-readable instructions to cause a processor of a network entity to: schedule, for a sensing apparatus, a positioning reference signal configuration of a positioning reference signal; and indicate, to the sensing apparatus, that the positioning reference signal is for radio frequency sensing.

An example radio frequency sensing method includes: scheduling, by a network entity, a radio frequency sensing reference signal; transmitting, from the network entity to a sensing apparatus, reference signal measurement assistance data; transmitting, from the network entity to the sensing apparatus, the radio frequency sensing reference signal; and receiving, at the network entity from the sensing apparatus, a measurement report corresponding to measurement of the radio frequency sensing reference signal.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5 is a simplified block diagram of an example sensing apparatus.

FIG. 6 is a simplified block diagram of an example network entity.

FIG. 7 is a simplified diagram of an environment for radio frequency sensing.

FIG. 8 is a timing diagram of a signaling and process flow for obtaining a sensing service.

FIG. 9 is another timing diagram of a signaling and process flow for obtaining a sensing service.

FIG. 10 is an example of a scheduling message for positioning reference signals for positioning and for sensing.

FIG. 11 is an example of a scheduling message for frequency layers for positioning and for sensing.

FIG. 12 is a timing diagram of prioritized reporting of positioning information and sensing information.

FIG. 13 is another timing diagram of prioritized reporting of positioning information and sensing information.

FIG. 14 is a timing diagram of transmission of a positioning reference signal for positioning and a positioning reference signal for sensing.

FIG. 15 is a block flow diagram of a radio frequency sensing method.

FIG. 16 is a block flow diagram of a positioning reference signal scheduling method.

FIG. 17 is a block flow diagram of another radio frequency sensing method.

### DETAILED DESCRIPTION

Techniques are discussed herein for radio frequency sensing. For example, a legacy positioning procedure (e.g., a New Radio user equipment positioning procedure) may be enhanced for radio frequency sensing using a reference signal (e.g., a channel state information reference signal or a positioning reference signal). As another example, a positioning reference signal may be scheduled and an indication provided that the positioning reference signal is to be used for radio frequency sensing. The positioning reference signal may also be used, and may be indicated to be used, for positioning. A positioning reference signal for sensing may be scheduled in the same frequency layer as a positioning reference signal for positioning. The indication that the positioning reference signal for sensing is to be used for sensing may comprise an indication that a frequency layer, that contains the positioning reference signal for sensing, is for sensing. These techniques are examples, and other implementations of techniques for radio frequency sensing may also or alternatively be used.

Items and/or techniques described herein may provide one or more of the following capabilities, as well as other capabilities not mentioned. Latency of radio frequency sensing may be reduced and/or kept low, e.g., when positioning and sensing are both performed. Priority of positioning and radio frequency sensing may be accommodated. Power consumption of a transmission/reception point and/or a user equipment may be saved. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

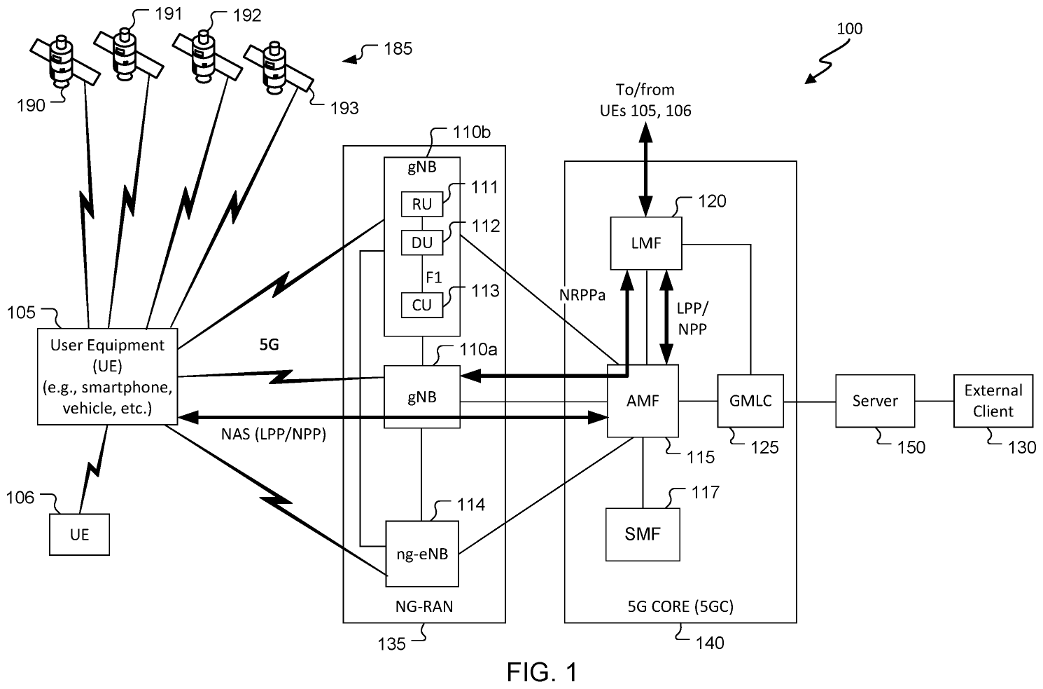

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more BSs, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS (Synchronization Signals) or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

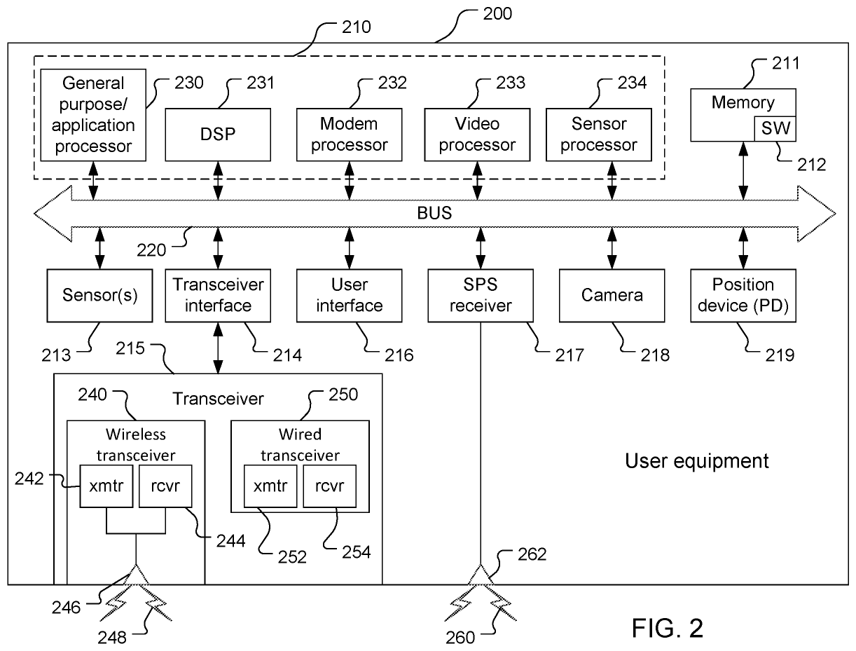

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

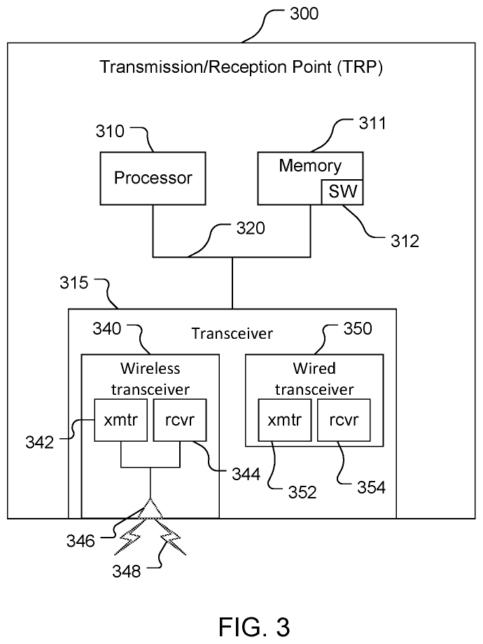

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

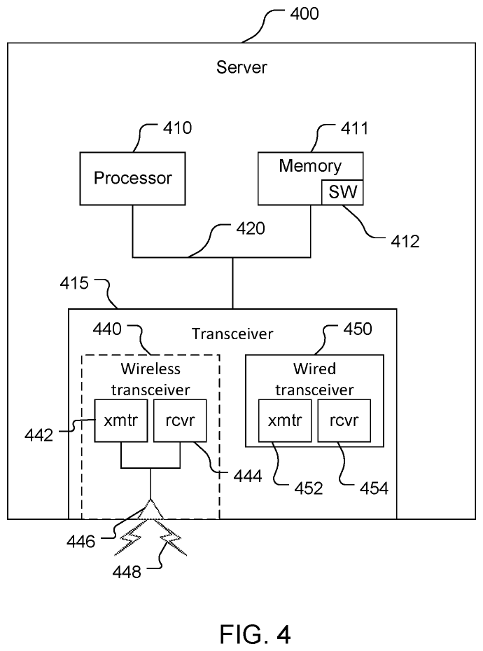

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120).

The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{RX-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS ((Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

### Radio Frequency Sensing

Radio frequency sensing (RF sensing) is a technique for sensing the presence and/or movement of one or more objects in an environment based, at least in part, on the transmission and reception of electromagnetic signals. RF sensing uses infrastructure (e.g., a base station and a UE) and time and frequency resources of a cellular communication system to measure an environment of a transmitting device and a receiving device to detect object presence and/or motion. Changes in the environment can be detected based on changes in a wireless communication channel between the transmitting device and the receiving device. For example, the presence or movement of the object(s) in the environment may interfere with or otherwise alter the phase or amplitude of wireless communication signals transmitted from the transmitting device, reflected by the object(s), and received by the receiving device, and thus, the wireless channel. The range of applications and/or accuracy of RF sensing may depend on an amount and/or detail of information communicated between the transmitting device and the receiving device.

A wireless communication network, e.g., conforming to the IEEE (Institute of Electrical and Electronics Engineers) 802.11 family of standards (such as a WLAN), may be used to implement an RF sensing system. The transmitting device may transmit a sounding dataset, over a wireless channel, to the receiving device. The sounding dataset may include information carried in one or more training fields configured for channel estimation and sounding control information based, at least in part, on a configuration of the transmitting device. The receiving device may acquire CSI for the wireless channel based on the received sounding dataset and selectively generate a channel report for the wireless channel based, at least in part, on the CSI and the sounding control information. For example, the receiving device may generate the channel report only when the characteristics of the wireless channel have changed by at least a threshold amount. The channel report may indicate changes to the wireless channel which, in turn, may be used to sense one or more objects in the vicinity of the transmitting device and/or the receiving device.

A CSI report may be provided, e.g., to a base station or other network entity, based on one or more measurements of CSI-RS (Channel State Information-Reference Signal(s)). For example, CSI may include CQI (Channel Quality Indicator(s)), RI (Rank Indicator(s)), and/or PMI (Precoding Matrix Indicator(s)) which may be derived from the one or more measurements of CSI-RS. Also or alternatively, CSI may include other information such as a CSI-RS Indicator (CRI), a Layer Indicator (LI), an SS/PBCH Block Resource Indicator (Synchronization Signal/Physical Broadcast Channel BRI (SSBRI)), and/or an L-1 RSRP (Layer 1 RSRP).

Techniques are discussed herein for using cellular communication systems (e.g., 5G and beyond) for RF sensing. Large bandwidths provided for such cellular communications systems may allow such cellular communication systems to provide accurate RF sensing services. Upper layer (e.g., MAC layer and above) procedures for positioning (e.g., NR UE positioning) may be reused or modified (e.g., enhanced) for providing RF sensing service. PRS may be used for RF sensing, e.g., due to the large bandwidth of PRS in the physical layer (PHY). For example, in FR1 (450 MHz-6 GHz (sub-6 GHz range)), PRS may have a bandwidth of 100 MHz, in FR2 (24.25 GHz-52.6 GHz (mm-wave)), PRS may have a bandwidth of 400 MHz, and for FR3 (10 GHz-20 GHz, e.g., 13 GHz), PRS may have a bandwidth of 200 MHz. In terahertz (THz) signaling, PRS may have a bandwidth of 1 GHz or more (e.g., for short-range (e.g., several meters) RF sensing). Also, carrier aggregation may be used to increase the bandwidth of the PRS.

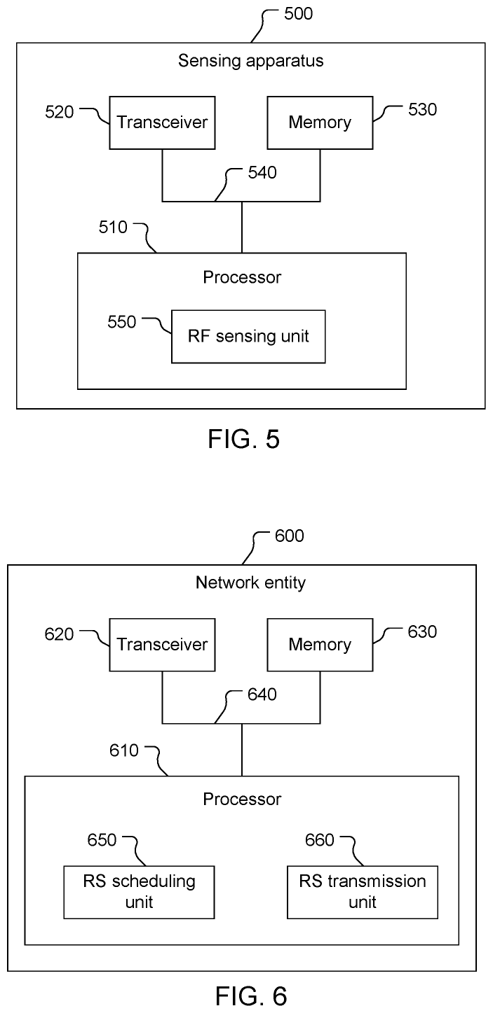

Referring also to FIG. 5, a sensing apparatus 500 includes a processor 510, a transceiver 520, and a memory 530 communicatively coupled to each other by a bus 540. The sensing apparatus 500 may include the components shown in FIG. 5. The sensing apparatus 500 may be, for example, a UE or a base station. For example, the sensing apparatus 500 may include one or more other components such as any of those shown in FIG. 2 such that the UE 200 may be an example of the sensing apparatus 500, and/or any of the components shown in FIG. 3 such that the TRP 300 may be an example of the sensing apparatus 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions. As another example, the processor 510 may include one or more of the components of the processor 310, the transceiver 520 may include one or more of the components of the transceiver 315, and the memory 530 may be configured similarly to the memory 311, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the sensing apparatus 500 performing a function as shorthand for one or more appropriate components (e.g., the processor 510 and the memory 530) of the sensing apparatus 500 performing the function. The processor 510 (possibly in conjunction with the memory 530 and, as appropriate, the transceiver 520) may include an RF sensing unit 550 (radio frequency sensing unit). The RF sensing unit 550 is discussed further below, and the description may refer to the processor 510 generally, or the sensing apparatus 500 generally, as performing any of the functions of the RF sensing unit 550. The sensing apparatus 500 is configured to perform the functions of the RF sensing unit 550 discussed herein.

Referring also to FIG. 6, a network entity 600 includes a processor 610, a transceiver 620, and a memory 630 communicatively coupled to each other by a bus 640. The network entity 600 may include the components shown in FIG. 6. The network entity 600 may include one or more other components such as any of those shown in FIG. 3 and/or FIG. 4 such that the TRP 300 and/or the server 400 may be an example of the network entity 600. For example, the processor 610 may include one or more of the components of the processor 310 and/or the processor 410. The transceiver 620 may include one or more of the components of the transceiver 315 and/or the transceiver 415. The memory 630 may be configured similarly to the memory 311 and/or the memory 411, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) may include an RS scheduling unit 650 and an RS transmission unit 660. The RS scheduling unit 650 and the RS transmission unit 660 are discussed further below, and the description may refer to the processor 610 generally, or the network entity 600 generally, as performing any of the functions of the RS scheduling unit 650 and/or the RS transmission unit 660. The network entity 600 is configured to perform the functions of the RS scheduling unit 650 and the RS transmission unit 660 discussed herein.

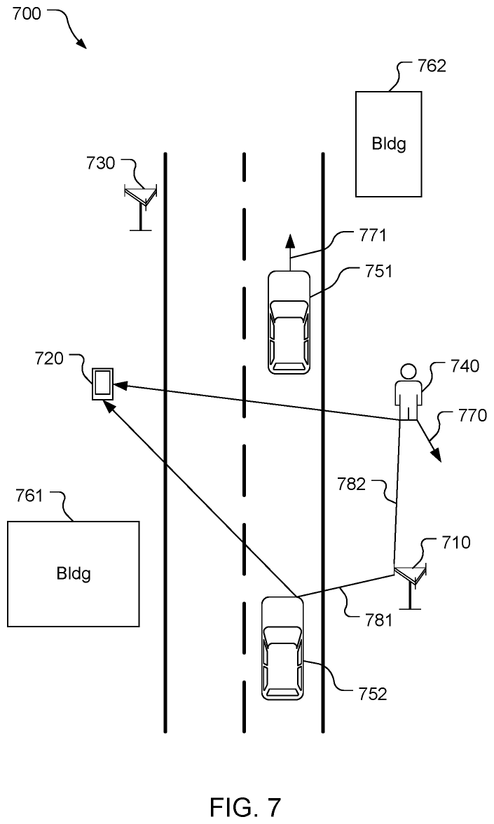

Referring also to FIG. 7, examples of the sensing apparatus 500 and the network entity 600 may be part of an environment 700 for RF sensing. For example, a base station 710 may be an example transmitter for RF sensing and a UE 720 and/or a base station 730 may be examples of the sensing apparatus 500 for sensing RS for RF sensing. The same entity, e.g., the base station 710, may be a transmitter and a receiver of RS for RF sensing for mono-static RF sensing. The base stations 710, 730 and the UE 720 may transmit and receive radio frequency RS in order to perform RF sensing. For example, the base station 710 transmits signals 781, 782 that reflect off a vehicle 752 and a person 740, respectively, and are received by the UE 720. The received signals may be measured to obtain one or more RS measurements and the measurement(s) may be used to determine one or more parameters based on the RS measurement(s), e.g., based on timing, magnitude, and direction of the received signals. The one or more parameters may include, for example, the presence of objects such as the person 740, a vehicle 751, and the vehicle 752, range(s) to one or more of the objects relative to one or more reference points, e.g., the base stations 710, 730 and/or the UE 720, direction of motion of one or more of the objects (relative to a reference such as a global direction reference), speed of one or more of the objects, etc. For example, a direction 771 of the vehicle 751 and/or a direction 770 of the person 740 may be determined relative to a global direction reference (e.g., north/east). The presence of stationary, persistent objects such as buildings 761, 762 may be determined and ignored, or may be used to determine motion of a device transmitting the RS measured by the sensing apparatus, e.g., the UE 720.

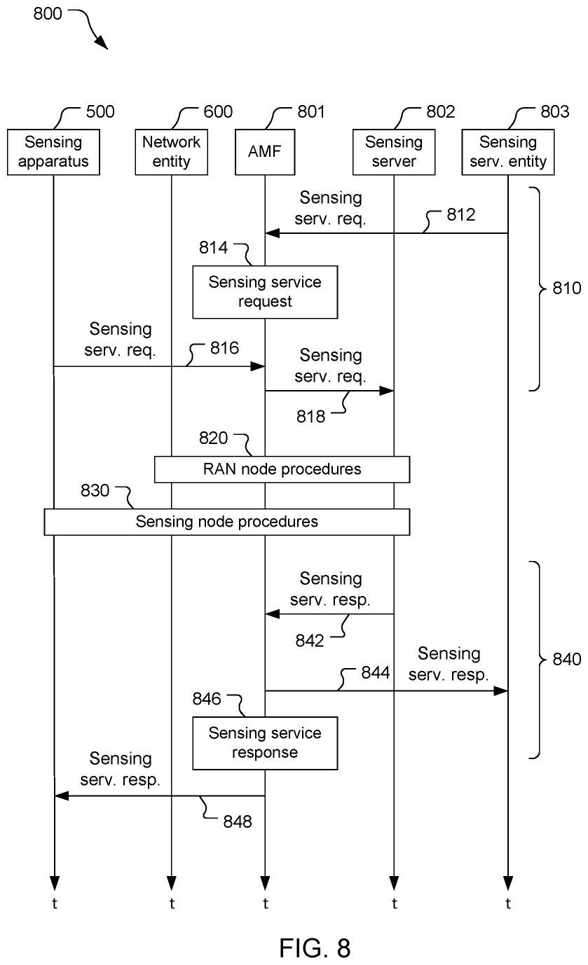

Referring also to FIG. 8, a timing diagram shows a signaling and process flow 800, for obtaining sensing service, that includes the stage shown. The flow 800 is an example and other flows are possible, e.g., with one or more stages shown omitted, one or more stages added, and/or one or more stages shown altered. For example, a stage 810 may be altered by having one or more sensing service requests omitted. As another example, a stage 840 may be altered by having one or more sensing service responses omitted. The signaling and process flow 800 is similar to a signaling and process flow for location services support by NG-RAN.

At stage 810, an RF sensing service request is made to a sensing server 802 (e.g., a sensing management function), with the sensing server 802 being an example of the server 400 (which may be part of the network entity 600). For example, a sensing service entity 803 may transmit a sensing service request 812 to an AMF 801 requesting one or more RF sensing services. The sensing service entity 803 may be disposed in the 5GC 140. Also or alternatively, at sub-stage 814, the AMF 801 may determine that one or more RF sensing services are desired (e.g., to determine object presence in an environment including the network entity 600 and the sensing apparatus 500, to determine range to one or more objects, to determine speed of one or more objects, and/or to determine movement of one or more objects). Also or alternatively, the sensing apparatus 500, e.g., the RF sensing unit 550, may transmit a sensing service request 816 to the AMF 801 requesting one or more RF sensing services. Based on the sensing service request 812, the determination of one or more desired sensing services at sub-stage 814, and/or the sensing service request 816, the AMF 801 transmits a sensing service request 818 to the sensing server 802 requesting one or more RF sensing services.

At stage 820, RAN node procedures are performed for obtaining RF sensing measurements and/or assistance data. For example, the sensing server 802 initiates RF sensing procedures to schedule one or more RF sensing service resources to allocate one or more RS resources for RF sensing. The network entity 600 may schedule the one or more RF sensing service resources, e.g., with a TRP of the network entity 600 and/or a server of the network entity 600 scheduling the RF sensing service resource(s). For example, the RS scheduling unit 650 (e.g., of the server 400 (e.g., the sensing server 802) and the TRP 300) may determine one or more RS resources and the TRP 300 may determine the transmission schedule(s) of the RS resource(s). The network entity 600 may determine assistance data for assisting the sensing apparatus to measure the RS resource(s) for RF sensing. For example, a TRP of the network entity 600 may determine the parameters of the transmission schedule(s) of the RS resource(s).

At stage 830, sensing node procedures are performed for obtaining RF sensing measurements (e.g., including providing the assistance data to the sensing apparatus 500). For example, the sensing server 802 initiates RS sensing procedures including transmission of RS (e.g., PRS and/or another type of RS, e.g., CSI-RS) by the network entity 600 (e.g., the RS transmission unit 660), measurement of the RS by the sensing apparatus 500 (e.g., the RF sensing unit 550), transmitting (to the sensing server 802 via the network entity 600 (which may include the sensing server 802)) an RF sensing measurement report. The measurement report may include RF sensing measurement(s) of RS received by the sensing apparatus 500 and/or of one or more parameters determined from the RF sensing measurement(s). The determined parameter(s) may include object presence, object range relative to a reference location (e.g., of the sensing apparatus), object direction relative to a reference direction (e.g., a global direction reference), object motion (e.g., speed), object size, and/or object shape, etc. The report may be sent by the sensing apparatus 500 to the sensing server 802 via the network entity 600 using LPP signaling. Multiple network entities (e.g., bases stations) may coordinate using NRPPa signaling to share information reported by different sensing apparatus. The RF sensing could be sensing-apparatus based (with the sensing apparatus 500 possibly not reporting sensing measurement(s) and sensing-measurement based parameter(s)) or network based (with the sensing apparatus 500 providing a report with sensing measurement(s) and/or sensing-measurement-based parameter(s) and the network, e.g., the network entity 600 or the sensing server 802 determining the sensing-measurement-based parameter(s)). Sensing-measurement-based parameters may include object size and/or object shape if there are sufficient measurements (e.g., sufficiently-dense signaling) to yield a cloud of measurements from which object size and/or object shape may be determined. RF sensing measurement may include Micro-Doppler shift, e.g., for detecting motion of an object such as respiration of a person. Artificial intelligence may be applied (e.g., by the network entity 600 and/or the sensing server 802 and/or the sensing apparatus 500 and/or another entity) to one or more RF sensing measurements to determine one or more sensing-measurement-based parameters.

At stage 840, one or more RF sensing service responses are provided to one or more appropriate entities. For example, the sensing server 802 may transmit a sensing service response 842 to the AMF 801. The sensing service response 842 may include CSI and/or one or more RF sensing measurement results on which CSI may be based, and may include an indication of successful or failed RF sensing measurement. The AMF 801 may, e.g., if the sensing service entity 803 sent the sensing service request 812 to the AMF 801, transmit a sensing service response 844 to the sensing service entity 803 indicating CSI and possibly the RF sensing measurement(s) on which the CSI may be based. At sub-stage 846, the AMF 801 may, e.g., if sub-stage 814 was performed, use the sensing service response 842 to assist with providing the sensing service(s) requested at sub-stage 814 (e.g., to provide object movement information (e.g., speed and/or direction)). As another example, the AMF 801 may, e.g., if the sensing apparatus sent the sensing service request 816 to the AMF 801, transmit a sensing service response 848 to the sensing apparatus 500 with requested RF sensing results (e.g., object presence, object movement, etc.).

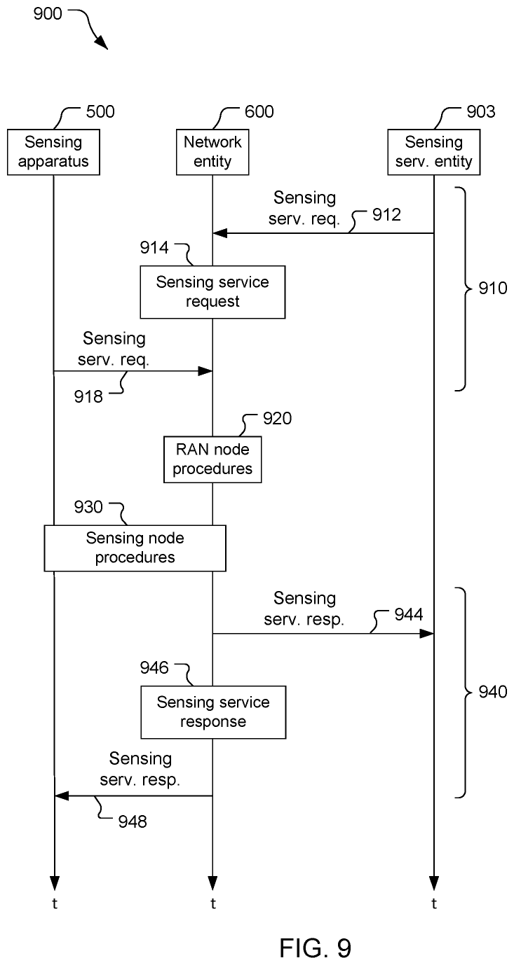

Referring also to FIG. 9, a timing diagram shows a signaling and process flow 900, for obtaining sensing service, that includes the stage shown. The flow 900 is an example and other flows are possible, e.g., with one or more stages shown omitted, one or more stages added, and/or one or more stages shown altered. The signaling and process flow 900 is similar to the signaling and process flow 800, but the signaling and process flow 900 is for a scenario where the network entity 600 includes the sensing server 802. Such a scenario provides for very low latency RF sensing, e.g., by eliminating the AMF 801 from communications between the network entity 600 and the sensing server 802.

At stage 910, an RF sensing service request is made to the network entity 600. For example, a sensing service entity 903 may transmit a sensing service request 912 to the network entity 600 requesting one or more RF sensing services. Also or alternatively, at sub-stage 914, the network entity 600, e.g., the RS scheduling unit 650, may determine that one or more RF sensing services are desired (e.g., to determine object presence in an environment including the network entity 600 and the sensing apparatus 500, to determine range to one or more objects, to determine speed of one or more objects, and/or to determine movement of one or more objects). Also or alternatively, the sensing apparatus 500, e.g., the RF sensing unit 550, may transmit a sensing service request 818 to the network entity 600 requesting one or more RF sensing services.

At stage 920, RAN node procedures are performed by the network entity 600 for obtaining RF sensing measurements and/or assistance data. For example, the network entity 600, e.g., the RS scheduling unit 650, initiates and performs RF sensing procedures to schedule one or more RF sensing service resources to allocate one or more RS resources for RF sensing. The network entity 600 may schedule the one or more RF sensing service resources, e.g., with a TRP of the network entity 600 and/or a server of the network entity 600 scheduling the RF sensing service resource(s). For example, the RS scheduling unit 650 (e.g., of the server 400 (e.g., a sensing server) and the TRP 300) may determine one or more RS resources and the TRP 300 may determine the transmission schedule(s) of the RS resource(s). The network entity 600 may determine assistance data for assisting the sensing apparatus to measure the RS resource(s) for RF sensing. For example, a TRP of the network entity 600 may determine the parameters of the transmission schedule(s) of the RS resource(s).

At stage 930, sensing node procedures are performed for obtaining RF sensing measurements (e.g., including providing the assistance data to the sensing apparatus 500). For example, the network entity 600, e.g., the RS transmission unit 660, initiates RS sensing procedures including transmission of RS by the network entity 600, measurement of the RS by the sensing apparatus 500 (e.g., the RF sensing unit 550), transmitting, from the sensing apparatus 500 to the network entity 600, an RF sensing measurement report of RF sensing measurement(s) of RS received by the sensing apparatus 500 and/or of one or more parameters determined from the RF sensing measurement(s).

At stage 940, one or more RF sensing service responses are provided to one or more appropriate entities. For example, the network entity 600 may, e.g., if the sensing service entity 903 sent the sensing service request 912 to the network entity 600, transmit a sensing service response 944 to the sensing service entity 903 indicating CSI and possibly the RF sensing measurement(s) on which the CSI may be based, and may include an indication of successful or failed RF sensing measurement. At sub-stage 946, the network entity 600 may, e.g., if sub-stage 914 was performed, use sensing measurements and/or parameters received at stage 930 to assist with providing the sensing service(s) requested at sub-stage 914 (e.g., to provide object movement information (e.g., speed and/or direction)). As another example, the network entity 600 may, e.g., if the sensing apparatus sent the sensing service request 816 to the network entity 600, transmit a sensing service response 948 to the sensing apparatus 500 with requested RF sensing results (e.g., object presence, object movement, etc.).

The network entity 600, e.g., the RS scheduling unit 650, may be configured to schedule various RS for RF sensing and/or positioning. For example, the RS scheduling unit 650 may be configured to configure a PRS resource and provide an indication that the PRS resource is to be used for RF sensing, for positioning, or both. The RS scheduling unit 650 may be configured to schedule RS for RF sensing and RS for positioning within the same frequency layer and/or in different frequency layers. The RS scheduling unit 650 may be configured to schedule one or more frequency layers dedicated to RF sensing and/or one or more frequency layers dedicated to positioning. For RS for RF sensing and RS for positioning scheduled in the same frequency layer, the RS scheduling unit 650 may provide an indication as to which RS resource(s) is(are) for positioning and which RS resource(s) is are for RF sensing. The RS scheduling unit 650 may provide an indication that one or more RS resources are for both RF sensing and positioning. Due to the large bandwidth of PRS, the RS scheduling unit may schedule PRS for RF sensing, with the PRS for RF sensing being dedicated for RF sensing or shared with one or more positioning functions. The PRS to be used for positioning may be referred to as simply PRS, legacy PRS, or PRS for positioning and the PRS to be used for RF sensing may be referred to as PRS for sensing or PRS for RF sensing.

Compared to positioning, fewer base stations may be used for RF sensing with a particular sensing apparatus. Due to longer path lengths involved with RF sensing (due to reflections of signals between transmitter and receiver) and thus higher path losses, fewer transmitters may be able to transmit signals to a receiver due to respective link budgets (i.e., the total of power gains and losses of respective signals from transmission to measurement). For example, while both of the base stations 710, 730 may be able to be used for positioning of the UE 720, perhaps only the base station 730 may be used for RF sensing with the UE 720 due to path lengths for RF sensing being too long for the received signals to be measured accurately by the UE 720. FIG. 7 is not shown to scale, and a transmitter and a receiver for RF sensing may be kilometers or even tens of kilometers apart, and thus reflected signal paths for RF sensing could be much greater than an LOS (line-of-sight paths) between the transmitter and receiver used for positioning.

The RS scheduling unit 650 may schedule PRS for positioning and PRS for sensing with the same common parameters of a frequency layer. The common parameters are common for the resource sets and resources within the frequency layer, but different frequency layers may have different common parameters. For example, the RS scheduling unit 650 may schedule PRS for positioning and PRS for sensing with the same SCS, CP type, the same carrier frequency, the same comb number, and the same bandwidth, whether the PRS for positioning and PRS for sensing are scheduled in the same frequency layer or different frequency layers. By using the same common parameters, the network entity 600 (e.g., the TRP 300) may be able to use the same components for transmitting PRS for positioning and PRS for sensing. By using the same common parameters, the sensing apparatus 500 may be able to use the same processing components (e.g., the same antenna, the same RF receive chain components (e.g., VGA (variable gain amplifier), filter(s), ADC (analog-to-digital converter), etc.)) which may reduce latency by avoiding retuning when switching from measuring PRS for positioning to measuring PRS for sensing and may reduce cost for the sensing apparatus by avoiding special components to measure PRS for sensing, and/or may provide one or more other advantages, e.g., saving power consumption at a transmission/reception point and/or a user equipment. The PRS for sensing, if scheduled in a separate frequency layers from the PRS for positioning, may not be constrained by a limitation on a quantity of allowed positioning frequency layers (PFLs). For example, if there is a limit of four PFLs, and four PFLs are scheduled, the RS scheduling unit 650 may be permitted to schedule one or more frequency layers for RF sensing in addition to the four scheduled PFLs.

The RS scheduling unit 650 may schedule PRS for positioning and PRS for sensing in different frequency layers, with the different frequency layers having one or more common parameters that are different from each other. For example, the RS scheduling unit 650 may schedule PRS for positioning in a positioning frequency layer (PFL) and schedule PRS for sensing in an RF-sensing frequency layer (RFL), with the RFL and PFL having one or more different time-domain allocation parameters, e.g., SCS and/or CP type. For example, a length of the CP for the RFL may be much shorter than (e.g., 1/10 as long as) a length of the CP for the PFL. As another example, a length of the waveform for sensing may be shorter than (e.g., ¼ as long as) the waveform for sensing. Consequently, the SCS for positioning (e.g., 30 kHz) may be lower than the SCS for sensing (e.g., 120 kHz). Also or alternatively, the RFL and PFL may be scheduled with one or more different frequency-domain allocation parameters, e.g., carrier frequency and/or different bandwidth. One or more other common parameters (e.g., comb number) may be the same even though one or more common parameters of the PFL and RFL are different (i.e., there may be some overlap in common parameter values between the PFL and RFL while one or more common parameter values are different between the PFL and RFL). For example, the RFL and PFL may have the same SCS, but different comb numbers, or the RFL and PFL could have the same SCS and comb number, but different bandwidths.

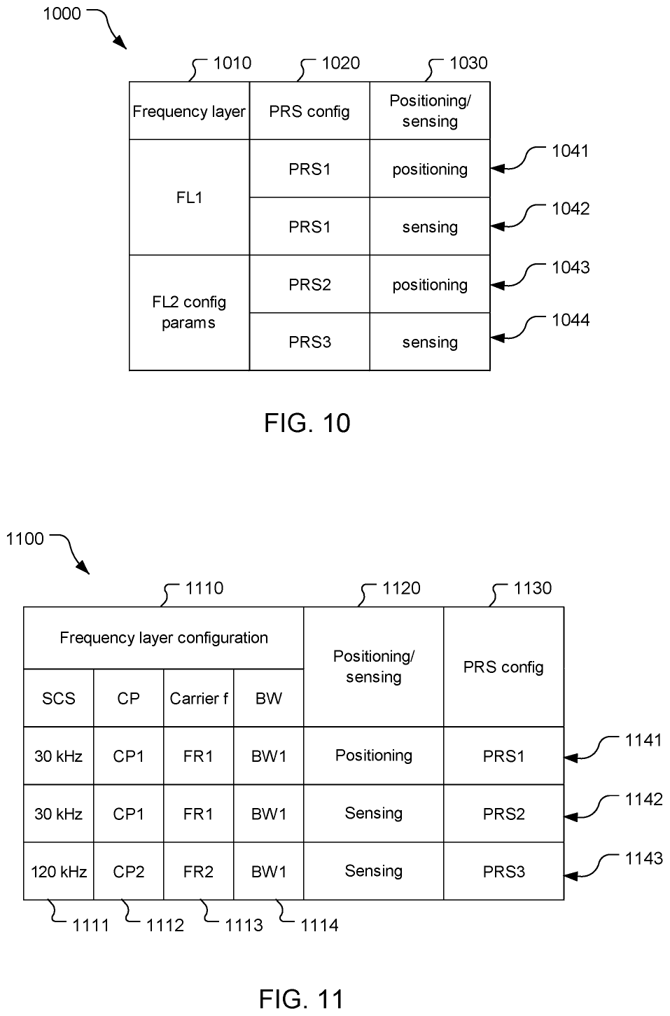

Referring also to FIG. 10, the RS scheduling unit 650 may be configured to transmit a scheduling message 1000 to the sensing apparatus 500. The scheduling message 1000 includes a frequency layer field 1010, a PRS configuration field 1020, and a positioning/sensing field 1030. Contents of the frequency layer field 1010 specify a frequency layer for which PRS are configured. The contents of the frequency layer field 1010 may be coded, with a coded value of a few bits (in this example, FL1) corresponding to a set of common parameter values for the frequency layer (which conserves overhead by having a few bits represent many more bits that would be used to specify the parameter values individually). Alternatively, the contents may include one or more indications of one or more common parameter values and a code for one or more other parameter values. Alternatively, the contents may indicate all of the common parameter values individually (shown in FIG. 10 in coded form as “FL2 config params”). Contents of the PRS configuration field 1020 indicate one or more parameter values (e.g., comb number, offset(s), etc.) for respective PRS. In this example, a PRS configuration of PRS1 corresponds to frequency layer FL1, and PRS configurations PRS2 and PRS3 correspond to the frequency layer specified by FL2 config params. Contents of the positioning/sensing field 1030 indicate whether a respective PRS corresponding to a respective PRS configuration indicated in the PRS configuration field 1020 is for positioning or RF sensing. In this example, entries 1041, 1042 indicate that the PRS configuration PRS1 of frequency layer FL1 is for both positioning and RF sensing. Also in this example, entries 1043, 1044 indicate that the PRS configuration PRS2 of frequency layer FL2 config params is for positioning and the PRS configuration PRS3 of frequency layer FL2 config params is for sensing. Thus, the same PRS (here for the PRS configuration PRS1) may be scheduled for positioning and RF sensing, which may help keep latency low (e.g., lower than if different PRS are used). For example, a report of positioning measurement(s) may be increased by several (e.g., 10) bits to include the sensing measurement(s). By using the same PRS resource or the same PRS resource set for positioning and sensing, the sensing apparatus 500 may perform sensing measurement before all PRS measurements are completed. Reporting of sensing measurement and positioning measurement based on the same PRS resource set or the same PRS resource may be subject to relative priority of sensing and positioning, e.g., as indicated by assistance data. Also, different PRS of the same frequency layer may be scheduled for positioning and RF sensing, but having the same common parameter values because the PRS are in the same frequency layer. The scheduling message 1000 is an example, and other scheduling messages may be used, e.g., with all frequency layers indicated by coded values.

Referring also to FIG. 11, the RS scheduling unit 650 may be configured to transmit a scheduling message 1100 to the sensing apparatus 500. The scheduling message 1100 indicates the same common parameter values for two different frequency layers for positioning and sensing, and also indicates frequency layers for positioning and sensing that have some identical common parameter values and some different common parameter values. The scheduling message 1100 includes a frequency layer configuration field 1110, a positioning/sensing field 1120, and a PRS configuration field 1130. Within the frequency layer configuration field 1110, the scheduling message 1100 includes an SCS sub-field 1111, a CP sub-field 1112, a carrier frequency sub-field 1113, and a bandwidth sub-field 1114. Contents of the positioning/sensing field 1120 indicate whether the corresponding frequency layer is for positioning or for sensing. Contents of entries 1141, 1142 correspond to PRS configurations PRS1, PRS2 that are for positioning and sensing, respectively, and correspond to different frequency layers that both have the same values for common parameters SCS, CP, carrier frequency, and bandwidth. Contents of entries 1141, 1143 correspond to PRS configurations PRS1, PRS3 that are for positioning and sensing, respectively, and correspond to different frequency layers that some common parameters of the same value and some common parameters with different values. Here, the SCS and CP values are different (30 kHz vs. 120 kHz, and CP1 vs. CP2) while the carrier frequency and the bandwidth are the same in the two different frequency layers. The sensing apparatus 500 may obtain one or more sensing measurements using an RS resource indicated to be for positioning or of a frequency layer indicated to be for positioning and/or may obtain one or more positioning measurements using an RS resource indicated to be for sensing or of a frequency layer indicated to be for sensing.

The network entity 600, e.g., the RS scheduling unit 650 may be configured to determine and provide, to the sensing apparatus, assistance data (AD) for the PRS for positioning and PRS for sensing. The assistance data include information that the sensing apparatus may use to help ensure and/or improve measurement of the PRS for positioning and the PRS for sensing. The assistance data may include, for example, a comb number, one or more offsets (e.g., slot offset, time offset, frequency offset, etc.), subcarrier spacing, priority information for PRS for positioning relative to PRS for sensing (e.g., measurement priority and/or measurement reporting priority), etc. The priority information may request the sensing apparatus 500 to prioritize the measurement(s) and/or reporting of the measurement(s) and/or the parameter(s) derived from the measurement(s) for PRS for positioning and PRS for sensing. The priority of positioning vs. sensing measurement(s) and/or measurement-derived parameter(s) may depend on one or more factors. For example, RF sensing and positioning may have one or more different QoS values, and the RS scheduling unit 650 may determine the relative priority of positioning vs. RF sensing based on the QoS values for positioning and sensing. For example, if RF sensing has a lower latency QoS value, then the RS scheduling unit 650 may indicate in the AD that reporting of RF sensing measurement(s)/parameter(s) has priority over reporting positioning measurement(s)/parameter(s) (with the parameter(s) being derived from the measurement(s). As another example, if an accuracy requirement is higher for one service than the other, then the higher-accuracy-requirement service may be prioritized to try to provide more dense reporting of measurement(s)/parameter(s) for that service. Parameters for positioning include, for example, target device range estimate and target device position estimate. Parameters for RF sensing include, for example, object presence, range, speed, and direction.

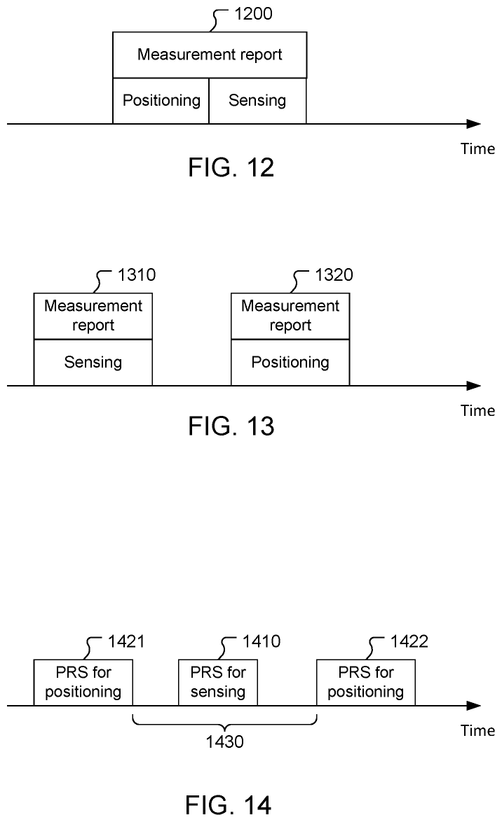

The sensing apparatus 500 may use the priority indication to determine whether to report positioning or sensing information and/or the order of reporting positioning and sensing information. For example, the sensing apparatus 500 may use the priority indication to determine the order of reporting positioning measurement(s)/parameter(s) and sensing measurement(s)/parameter(s). Referring also to FIG. 12, with positioning having higher priority the sensing apparatus 500 may transmit a measurement report 1200 that includes positioning information (measurement(s)/parameter(s)) before sensing information (measurement(s)/parameter(s)). Also or alternatively, the sensing apparatus 500 may use the priority indication to determine which positioning measurement(s)/parameter(s) or sensing measurement(s)/parameter(s) to report if the sensing apparatus 500 is unable to report all of the positioning measurement(s)/parameter(s) and sensing measurement(s)/parameter(s), e.g., within a reporting cycle. For example, a reporting capability (e.g., allocated resources for reporting) of the sensing apparatus 500 may not permit the sensing apparatus 500 to report all of the positioning and sensing measurement(s)/parameter(s) in a single report even if sensing and positioning information are both available (e.g., having been determined from PRS for positioning and PRS for sensing in a single instance). The sensing apparatus 500 may use the positioning/sensing priority to determine which measurement(s)/parameter(s) to report in the next report, and which to report (if at all) in a subsequent (e.g., the next) report. For example, referring also to FIG. 13, with sensing having priority over positioning, and the sensing apparatus 500 unable to report both positioning information and sensing information in the same reporting instance, the sensing apparatus transmits, in a first reporting instance, a measurement report 1310 including sensing information and transmits, in a second reporting instance after the first reporting instance, a measurement report 1320 including positioning information.

The network entity 600, e.g., the RS scheduling unit 650, may schedule PRS for sensing and PRS for positioning jointly such that the RS scheduling unit 650 determines the PRS configuration of the PRS for positioning in concert with (e.g., time division multiplexed with) the PRS configuration of the PRS for sensing, and vice versa. For example, referring also to FIG. 14, the RS scheduling unit 650 may schedule PRS for sensing 1410 within a time gap 1430 between a first instance 1421 of PRS for positioning and a second instance 1422 of the PRS for positioning. Thus, the RS scheduling unit 650 may take advantage of a periodicity of the PRS for positioning to schedule PRS for sensing, which may provide lower latency for RF sensing than scheduling the PRS for sensing after all instances of PRS for positioning. As another example, if the QoS for positioning and sensing are similar, then the RS scheduling unit 650 may schedule PRS to be shared for both positioning and sensing.

The RS scheduling unit 650 may determine TRPs to transmit PRS for sensing based on locations of the TRPs and a location of the sensing apparatus 500. The RS scheduling unit 650 may be configured to schedule PRS for sensing to be transmitted by TRPs near the sensing apparatus 500, i.e., by TRPs from which transmitted PRS are expected to be received by the sensing apparatus 500 with sufficient energy for acceptable RF sensing measurement. Thus, the RS scheduling unit 650 may schedule PRS for positioning from a subset of TRPs transmitting the PRS for positioning to be shared with RF sensing, e.g., due to the PRS for positioning from a subset of TRPs being received by the sensing apparatus 500 with sufficient energy for acceptable RF sensing measurement. A serving base station and neighbor base stations may provide sufficient TRPs for RF sensing, with the sensing apparatus 500 being one of those base stations or separate from those base stations, e.g., being a UE.

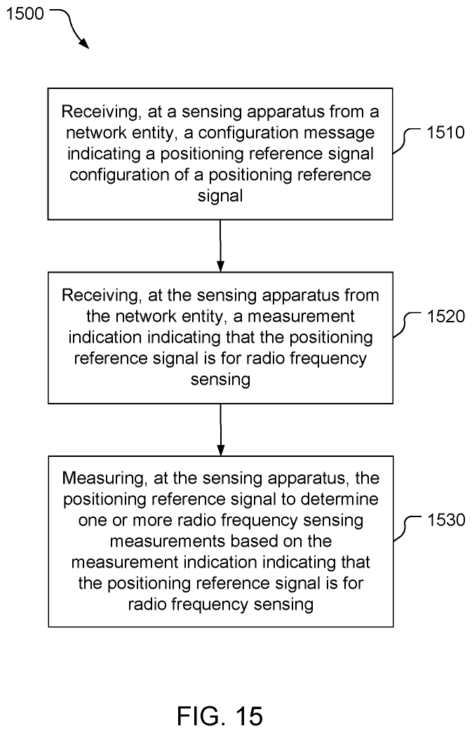

Referring to FIG. 15, with further reference to FIGS. 1-14, a radio frequency sensing method 1500 includes the stages shown. The method 1500 is, however, an example and not limiting. The method 1500 may be altered, e.g., by having stages added, removed, rearranged, combined, performed concurrently, and/or having single stages split into multiple stages.

At stage 1510, the method 1500 includes receiving, at a sensing apparatus from a network entity, a configuration message indicating a positioning reference signal configuration of a positioning reference signal. For example, the sensing apparatus 500 may receive (e.g., at stage 830 or stage 930) from the network entity 600, e.g., the RS scheduling unit 650, a scheduling message with a PRS configuration. The scheduling message may be, for example, the scheduling message 1000, or the scheduling message 1100, or another scheduling message. The network entity 600 may be or include a TRP and/or a server to transmit the configuration message to a UE or base station sensing apparatus. The processor 510, possibly in combination with the memory 530, in combination with the transceiver 520 (e.g., the wireless receiver 244 and the antenna 246, or the wired receiver 354) may comprise means for receiving the configuration message.

At stage 1520, the method 1500 includes receiving, at the sensing apparatus from the network entity, a measurement indication indicating that the positioning reference signal is for radio frequency sensing. For example, the sensing apparatus 500 may receive an indication (e.g., in the positioning/sensing field 1030) that the PRS configuration is for radio frequency sensing or an indication (e.g., in the positioning/sensing field 1120) that a frequency layer containing the PRS configuration is for radio frequency sensing. The processor 510, possibly in combination with the memory 530, in combination with the transceiver 520 (e.g., the wireless receiver 244 and the antenna 246, or the wired receiver 354) may comprise means for receiving the measurement indication.

At stage 1530, the method 1500 includes measuring, at the sensing apparatus, the positioning reference signal to determine one or more radio frequency sensing measurements based on the measurement indication indicating that the positioning reference signal is for radio frequency sensing. For example, the RF sensing unit 550 of the processor 510 (e.g., a filter, a low-noise amplifier, an analog-to-digital converter, and a DSP) measures the PRS to determine one or more RF sensing measurements (e.g., angle of arrival, received power, time of arrival, Doppler, Micro-Doppler, etc.). The processor 510, possibly in combination with the memory 530, in combination with the transceiver 520 (e.g., the wireless receiver 244 and the antenna 246, or the wireless receiver 344 and the antenna 346) may comprise means for measuring the PRS to determine one or more radio frequency sensing measurements.

Implementations of the method 1500 may include one or more of the following features. In an example implementation, measuring the positioning reference signal comprises measuring, in response to the measurement indication indicating that the positioning reference signal is also for positioning, the positioning reference signal to determine one or more positioning measurements. For example, the processor 510 may determine one or more positioning measurements (e.g., earliest time of arrival, RSRP) by measuring the PRS based on the sensing apparatus 500 receiving an indication (e.g., in the entry 1041) that the PRS is also for positioning. The processor 510 may also determine other position information based on the positioning measurement(s) (e.g., a position estimate for the sensing apparatus 500, a pseudorange to a TRP that transmitted the PRS, etc.). The processor 510, possibly in combination with the memory 530, in combination with the transceiver 520 (e.g., the wireless receiver 244 and the antenna 246, or the wireless receiver 344 and the antenna 346) may comprise means for measuring the PRS to determine one or more positioning measurements.

Also or alternatively, implementations of the method 1500 may include one or more of the following features. In an example implementation, the positioning reference signal is a first positioning reference signal, and wherein the radio frequency sensing method further comprises: measuring, at the sensing apparatus, at least one of the first positioning reference signal or a second positioning reference signal to determine one or more positioning measurements; receiving, at the sensing apparatus from the network entity, a priority indication indicating a priority of the one or more radio frequency sensing measurements and the one or more positioning measurements; and reporting, to the network entity, the one or more radio frequency sensing measurements, or the one or more positioning measurements, or a combination thereof, based on the priority of the one or more radio frequency sensing measurements and the one or more positioning measurements, and based on a reporting capability of the sensing apparatus. For example, the network entity 600 can provide the sensing apparatus 500 with an indication of priority of RF sensing relative to positioning for the sensing apparatus 500. The sensing apparatus 500 may measure the PRS for sensing and the PRS for positioning (which may be the same PRS or different PRS), and report RF sensing measurement(s) and/or positioning measurement(s) based on the priority and a capability of the sensing apparatus 500 (e.g., a capability to report the measurements in a single reporting instance). For example, the sensing apparatus 500 may transmit the measurement report 1200 based on positioning being higher priority and the sensing apparatus 500 being able to report positioning information and sensing information in a single report. As another example, the sensing apparatus 500 may transmit the measurement reports 1310, 1320 based on sensing being higher priority and the sensing apparatus 500 being unable to report positioning information and sensing information in a single report. As another example, the sensing apparatus 500 may transmit the measurement report 1310 and not transmit the measurement report 1320 based on sensing being higher priority and the sensing apparatus 500 being unable to report positioning information and sensing information in a single report. The processor 510, possibly in combination with the memory 530, in combination with the transceiver 520 (e.g., the wireless receiver 244 and the antenna 246, or the wireless receiver 344 and the antenna 346) may comprise means for measuring at least one of the first PRS or the second PRS. The processor 510, possibly in combination with the memory 530, in combination with the transceiver 520 (e.g., the wireless receiver 244 and the antenna 246, or the wired receiver 354) may comprise means for receiving the priority indication. The processor 510, possibly in combination with the memory 530, in combination with the transceiver 520 (e.g., the wireless transmitter 242 and the antenna 246, or the wired transmitter 352) may comprise means for reporting the one or more radio frequency sensing measurements, or the one or more positioning measurements, or a combination thereof.

Also or alternatively, implementations of the method 1500 may include one or more of the following features. In an example implementation, the measurement indication indicates that a frequency layer, corresponding to the positioning reference signal, is for radio frequency sensing. For example, the measurement indication may comprise a scheduling message such as the scheduling message 1100 that indicates, in the positioning/sensing field 1120, whether a frequency layer is for radio frequency sensing (or for positioning).

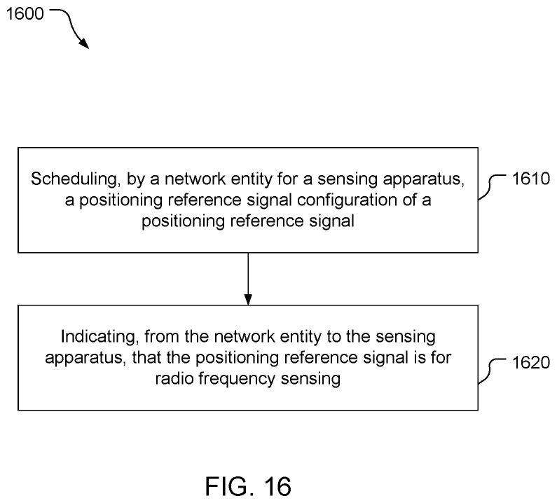

Referring to FIG. 16, with further reference to FIGS. 1-14, a positioning reference signal scheduling method 1600 includes the stages shown. The method 1600 is, however, an example and not limiting. The method 1600 may be altered, e.g., by having stages added, removed, rearranged, combined, performed concurrently, and/or having single stages split into multiple stages.

At stage 1610, the method 1600 includes scheduling, by a network entity for a sensing apparatus, a positioning reference signal configuration of a positioning reference signal. For example, at stage 820 or stage 920, the network entity 600 (e.g., the TRP 300 and/or the sensing server 802 (e.g., the server 400)) may schedule a PRS configuration (e.g., comb number, offsets, repetition factor, number of symbols, etc.) of a PRS to be received by the sensing apparatus 500. The processor 610 (e.g., the processor 310 and/or the processor 410), possibly in combination with the memory 630 (e.g., the memory 311 and/or the memory 411), possibly in combination with the transceiver 620 (e.g., the transceiver 415 (e.g., the wired transmitter 452)) may comprise means for scheduling the PRS configuration of the PRS. Scheduling the PRS configuration may comprise transmitting the PRS configuration to the sensing apparatus, and thus the means for scheduling the PRS configuration may comprise, e.g., the wireless transmitter 342 and the antenna 346.

At stage 1620, the method 1600 includes indicating, from the network entity to the sensing apparatus, that the positioning reference signal is for radio frequency sensing. For example, the network entity 600 may transmit a scheduling message, e.g., the scheduling message 1000 or the scheduling message 1100, indicating that the PRS is for RF sensing. The processor 610 (e.g., the processor 310 and/or the processor 410), possibly in combination with the memory 630 (e.g., the memory 311 and/or the memory 411), possibly in combination with the transceiver 620 (e.g., the transceiver 315 (e.g., the wireless transmitter 342 and the antenna 346) and possibly the transceiver 415 (e.g., the wired transmitter 452)) may comprise means for indicating that the PRS is for RF sensing.

Implementations of the method 1600 may include one or more of the following features. In an example implementation, the positioning reference signal is a first positioning reference signal, and wherein the positioning reference signal scheduling method further comprises: scheduling, by the network entity, a first frequency layer including the first positioning reference signal; scheduling, by the network entity for the sensing apparatus, a second frequency layer including a second positioning reference signal; and indicating, by the network entity to the sensing apparatus, that the second positioning reference signal is for positioning. For example, the network entity 600 may schedule PRS for sensing and PRS for positioning in the same or different frequency layers and may indicate that the PRS for positioning is for positioning. The network entity 600 may, for example, provide the indication of the PRS for positioning being for positioning in the scheduling message 1000 or the scheduling message 1100. The processor 610 (e.g., the processor 310 and/or the processor 410), possibly in combination with the memory 630 (e.g., the memory 311 and/or the memory 411), possibly in combination with the transceiver 620 (e.g., the transceiver 315 (e.g., the wireless transmitter 342 and the antenna 346) and/or the transceiver 415 (e.g., the wired transmitter 452)) may comprise means for scheduling the first frequency layer and means for scheduling the second frequency layer. The processor 610 (e.g., the processor 310 and/or the processor 410), possibly in combination with the memory 630 (e.g., the memory 311 and/or the memory 411), possibly in combination with the transceiver 620 (e.g., the transceiver 315 (e.g., the wireless transmitter 342 and the antenna 346) and possibly the transceiver 415 (e.g., the wired transmitter 452)) may comprise means for indicating that the second PRS is for positioning. In a further example implementation, first configuration parameter values that are common throughout the first frequency layer are identical to corresponding second configuration parameter values that are common through the second frequency layer. For example, the first and second frequency layers may be the same frequency layer (e.g., as indicated in the scheduling message 1000), or may be different frequency layers with identical values of (all) common parameters in the two frequency layers (e.g., as indicated in the scheduling message 1100). In another further example implementation, at least one of a plurality of first configuration parameter values that are common throughout the first frequency layer is different from at least one corresponding second configuration parameter value of a plurality of second configuration parameter values that are common through the second frequency layer. For example, as shown in the entries 1141, 1143 of the scheduling message 1100, one or more common parameters may be different in the different frequency layers. In another example implementation, at least one positioning reference signal resource set is shared by the first frequency layer and the second frequency layer, or at least one positioning reference signal resource is shared by the first frequency layer and the second frequency layer, or a combination thereof. For example, the PRS configuration PRS2 in the entry 1043 and the PRS configuration PRS3 in the entry 1044 of the scheduling message may include a shared PRS resource set or a shared PRS resource. In another further example implementation, the method 1600 includes indicating, by the network entity to the sensing apparatus, that the first frequency layer is for radio frequency sensing and that the second frequency layer is for positioning. For example, the network entity may indicate, e.g., in the positioning/sensing field 1120 of the scheduling message 1100, that respective frequency layers (FR1 and FR2 in the scheduling message 1100) are for positioning and for sensing, respectively.

Also or alternatively, implementations of the method 1600 may include one or more of the following features. In an example implementation, the positioning reference signal is a first positioning reference signal, and the method 1600 includes scheduling transmission of the first positioning reference signal in a time gap between scheduled transmissions of a second positioning reference signal indicated to be for positioning. For example, the network entity 600 may schedule the PRS for positioning and the PRS for sensing as shown in FIG. 14, with the PRS for sensing being transmitting in in a time gap between transmission of instances of the PRS for positioning. The processor 610 (e.g., the processor 310 and/or the processor 410), possibly in combination with the memory 630 (e.g., the memory 311 and/or the memory 411), possibly in combination with the transceiver 620 (e.g., the transceiver 315 (e.g., the wireless transmitter 342 and the antenna 346) and/or the transceiver 415 (e.g., the wired transmitter 452)) may comprise means for scheduling the second PRS. In another example implementation, the method 1600 includes scheduling, by the network entity, transmission of the positioning reference signal by a base station based on a proximity of the base station to the sensing apparatus. For example, the network entity 600 may schedule PRS for sensing from a TRP based on proximity of the TRP and the sensing apparatus 500, e.g., such that the PRS for sensing is expected to reach the sensing apparatus 500 with sufficient power to be measured accurately, e.g., such that the TRP is a serving TRP for the sensing apparatus 500 or a neighbor TRP of the serving TRP. The processor 610 (e.g., the processor 310 and/or the processor 410), possibly in combination with the memory 630 (e.g., the memory 311 and/or the memory 411), possibly in combination with the transceiver 620 (e.g., the transceiver 315 (e.g., the wireless transmitter 342 and the antenna 346) and/or the transceiver 415 (e.g., the wired transmitter 452)) may comprise means for scheduling transmission of the PRS by a base station based on proximity of the base station to the sensing apparatus. In another example implementation, the method 1600 includes transmitting a priority indication to the sensing apparatus indicating a priority of positioning relative to radio frequency sensing. For example, the network entity 600 may send an indication to the sensing apparatus 500 indicating whether reporting of measurement(s)/parameter(s) for positioning has higher or lower priority than reporting of measurement(s)/parameter(s) for radio frequency sensing. The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless transmitter 342 and the antenna 346) and possibly the transceiver 415 (e.g., the wired transmitter 452)) may comprise means for transmitting the priority indication to the sensing apparatus.

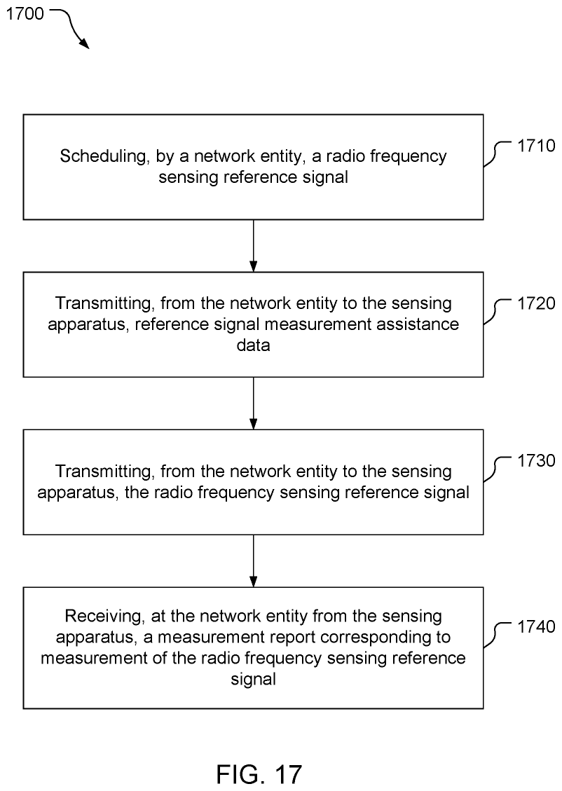

Referring to FIG. 17, with further reference to FIGS. 1-14, a radio frequency sensing method 1700 includes the stages shown. The method 1700 is, however, an example and not limiting. The method 1700 may be altered, e.g., by having stages added, removed, rearranged, combined, performed concurrently, and/or having single stages split into multiple stages.

At stage 1710, the method 1700 includes scheduling, by a network entity, a radio frequency sensing reference signal. For example, at stage 820 or stage 920 the network entity 600, e.g., RS scheduling unit 650, schedules an RS (e.g., by allocating one or more RS resources). The processor 610 (e.g., the processor 310 and/or the processor 410), possibly in combination with the memory 630 (e.g., the memory 311 and/or the memory 411), possibly in combination with the transceiver 620 (e.g., the transceiver 315 (e.g., the wireless transmitter 342 and the antenna 346) and possibly the transceiver 415 (e.g., the wired transmitter 452)) may comprise means for scheduling the PRS configuration of the PRS. Scheduling the RS may comprise transmitting the RS configuration to the sensing apparatus, and thus the means for scheduling the RS may comprise, e.g., the wireless transmitter 342 and the antenna 346.

At stage 1720, the method 1700 includes transmitting, from the network entity to a sensing apparatus, reference signal measurement assistance data. For example, at stage 830 or stage 930 the network entity 600 provides assistance data to the sensing apparatus 500 to assist the sensing apparatus 500 with measuring the RS. The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless transmitter 342 and the antenna 346) and possibly the transceiver 415 (e.g., the wired transmitter 452)) may comprise means for transmitting the reference signal measurement assistance data.

At stage 1730, the method 1700 includes transmitting, from the network entity to the sensing apparatus, the radio frequency sensing reference signal. For example, at stage 830 or stage 930 the network entity 600 (e.g., the RS transmission unit 660) transmits the radio frequency sensing reference signal to the sensing apparatus 500. The processor 610 (e.g., the processor 310), possibly in combination with the memory 630 (e.g., the memory 311), in combination with the transceiver 620 (e.g., the transceiver 315 (e.g., the wireless transmitter 342 and the antenna 346)) may comprise means for transmitting the radio frequency sensing reference signal to the sensing apparatus.

At stage 1740, the method 1700 includes receiving, at the network entity from the sensing apparatus, a measurement report corresponding to measurement of the one or more radio frequency sensing reference signal resources. For example, at stage 830 or stage 930, the sensing apparatus 500 may transmit a report to the network entity 600 with sensing measurement(s)/parameter(s) based on measurement of the radio frequency sensing reference signal. The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless receiver 344 and the antenna 346) and/or the transceiver 415 (e.g., the wired receiver 454)) may comprise means for receiving the measurement report.

Implementations of the method 1700 may include one or more of the following features. In an example implementation, the method 1700 includes: receiving, from a requesting entity, a request for radio frequency sensing; and transmitting, from the network entity to the requesting entity, a radio frequency sensing response based on the measurement report. For example, at stage 910 the network entity 600 receives the sensing service request 912 from the sensing service entity 903 and at stage 940 the network entity 600 transmits the sensing service response 944 to the sensing service entity 903 as discussed above. As another example, at stage 910 the network entity 600 receives the sensing service request 918 from the sensing apparatus 500 and at stage 940 the network entity 600 transmits the sensing service response 948 to the sensing apparatus 500 as discussed above. The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless receiver 344 and the antenna 346) and/or the transceiver 415 (e.g., the wired receiver 454)) may comprise means for receiving the request for radio frequency sensing. The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless transmitter 342 and the antenna 346) and/or the transceiver 415 (e.g., the wired transmitter 452)) may comprise means for transmitting the radio frequency sensing response. In a further example implementation, the requesting entity may comprise a user equipment or a base station.

### Implementation Examples

Implementation examples are provided in the following numbered clauses.

Clause 1. A sensing apparatus comprising:
a memory;
a transceiver; and
a processor, communicatively coupled to the memory and the transceiver, configured to:
   receive, via the transceiver from a network entity, a configuration message indicating a positioning reference signal configuration of a positioning reference signal;
   receive, via the transceiver from the network entity, a measurement indication indicating that the positioning reference signal is for radio frequency sensing; and
   measure the positioning reference signal to determine one or more radio frequency sensing measurements based on the measurement indication indicating that the positioning reference signal is for radio frequency sensing.

Clause 2. The sensing apparatus of clause 1, wherein the processor is configured to measure, in response to the measurement indication indicating that the positioning reference signal is also for positioning, the positioning reference signal to determine one or more positioning measurements.

Clause 3. The sensing apparatus of clause 1, wherein the positioning reference signal is a first positioning reference signal, and wherein the processor is configured to:
measure at least one of the first positioning reference signal or a second positioning reference signal to determine one or more positioning measurements;
receive, via the transceiver from the network entity, a priority indication indicating a priority of the one or more radio frequency sensing measurements and the one or more positioning measurements; and
report, via the transceiver to the network entity, the one or more radio frequency sensing measurements, or the one or more positioning measurements, or a combination thereof, based on the priority of the one or more radio frequency sensing measurements and the one or more positioning measurements, and based on a reporting capability of the sensing apparatus.

Clause 4. The sensing apparatus of clause 1, wherein the measurement indication indicates that a frequency layer, corresponding to the positioning reference signal, is for radio frequency sensing.

Clause 5. A radio frequency sensing method comprising:
receiving, at a sensing apparatus from a network entity, a configuration message indicating a positioning reference signal configuration of a positioning reference signal;
receiving, at the sensing apparatus from the network entity, a measurement indication indicating that the positioning reference signal is for radio frequency sensing; and
measuring, at the sensing apparatus, the positioning reference signal to determine one or more radio frequency sensing measurements based on the measurement indication indicating that the positioning reference signal is for radio frequency sensing.

Clause 6. The radio frequency sensing method of clause 5, wherein measuring the positioning reference signal comprises measuring, in response to the measurement indication indicating that the positioning reference signal is also for positioning, the positioning reference signal to determine one or more positioning measurements.

Clause 7. The radio frequency sensing method of clause 5, wherein the positioning reference signal is a first positioning reference signal, and wherein the radio frequency sensing method further comprises:
measuring, at the sensing apparatus, at least one of the first positioning reference signal or a second positioning reference signal to determine one or more positioning measurements;
receiving, at the sensing apparatus from the network entity, a priority indication indicating a priority of the one or more radio frequency sensing measurements and the one or more positioning measurements; and
reporting, to the network entity, the one or more radio frequency sensing measurements, or the one or more positioning measurements, or a combination thereof, based on the priority of the one or more radio frequency sensing measurements and the one or more positioning measurements, and based on a reporting capability of the sensing apparatus.

Clause 8. The radio frequency sensing method of clause 5, wherein the measurement indication indicates that a frequency layer, corresponding to the positioning reference signal, is for radio frequency sensing.

Clause 9. A sensing apparatus comprising:
means for receiving, from a network entity, a configuration message indicating a positioning reference signal configuration of a positioning reference signal;
means for receiving, from the network entity, a measurement indication indicating that the positioning reference signal is for radio frequency sensing; and
means for measuring the positioning reference signal to determine one or more radio frequency sensing measurements based on the measurement indication indicating that the positioning reference signal is for radio frequency sensing.

Clause 10. The sensing apparatus of clause 9, wherein the means for measuring the positioning reference signal comprise means for measuring, in response to the measurement indication indicating that the positioning reference signal is also for positioning, the positioning reference signal to determine one or more positioning measurements.

Clause 11. The sensing apparatus of clause 9, wherein the positioning reference signal is a first positioning reference signal, and wherein the sensing apparatus further comprises:
means for measuring at least one of the first positioning reference signal or a second positioning reference signal to determine one or more positioning measurements;
means for receiving, from the network entity, a priority indication indicating a priority of the one or more radio frequency sensing measurements and the one or more positioning measurements; and
means for reporting, to the network entity, the one or more radio frequency sensing measurements, or the one or more positioning measurements, or a combination thereof, based on the priority of the one or more radio frequency sensing measurements and the one or more positioning measurements, and based on a reporting capability of the sensing apparatus.

Clause 12. The sensing apparatus of clause 9, wherein the measurement indication indicates that a frequency layer, corresponding to the positioning reference signal, is for radio frequency sensing.

Clause 13. A non-transitory, processor-readable storage medium comprising processor-readable instructions to cause a processor of a sensing apparatus to:
receive, from a network entity, a configuration message indicating a positioning reference signal configuration of a positioning reference signal;
receive, from the network entity, a measurement indication indicating that the positioning reference signal is for radio frequency sensing; and
measure the positioning reference signal to determine one or more radio frequency sensing measurements based on the measurement indication indicating that the positioning reference signal is for radio frequency sensing.

Clause 14. The non-transitory, processor-readable storage medium of clause 13, wherein the processor-readable instructions to cause the processor to measure the positioning reference signal comprise processor-readable instructions to cause the processor to measure, in response to the measurement indication indicating that the positioning reference signal is also for positioning, the positioning reference signal to determine one or more positioning measurements.

Clause 15. The non-transitory, processor-readable storage medium of clause 13, wherein the positioning reference signal is a first positioning reference signal, and wherein the non-transitory, processor-readable storage medium further comprises processor-readable instructions to cause the processor to:
measure at least one of the first positioning reference signal or a second positioning reference signal to determine one or more positioning measurements;
receive, from the network entity, a priority indication indicating a priority of the one or more radio frequency sensing measurements and the one or more positioning measurements; and
report, to the network entity, the one or more radio frequency sensing measurements, or the one or more positioning measurements, or a combination thereof, based on the priority of the one or more radio frequency sensing measurements and the one or more positioning measurements, and based on a reporting capability of the sensing apparatus.

Clause 16. The non-transitory, processor-readable storage medium of clause 13, wherein the measurement indication indicates that a frequency layer, corresponding to the positioning reference signal, is for radio frequency sensing.

Clause 17. A network entity comprising:
a memory;
a transceiver; and a processor, communicatively coupled to the memory and the transceiver, configured to:
   schedule, for a sensing apparatus, a positioning reference signal configuration of a positioning reference signal; and
   indicate, to the sensing apparatus, that the positioning reference signal is for radio frequency sensing.

Clause 18. The network entity of clause 17, wherein the positioning reference signal is a first positioning reference signal, and wherein the processor is configured to:
schedule a first frequency layer including the first positioning reference signal;
schedule, for the sensing apparatus, a second frequency layer including a second positioning reference signal; and
indicate, to the sensing apparatus, that the second positioning reference signal is for positioning.

Clause 19. The network entity of clause 18, wherein first configuration parameter values that are common throughout the first frequency layer are identical to corresponding second configuration parameter values that are common through the second frequency layer.

Clause 20. The network entity of clause 18, wherein at least one of a plurality of first configuration parameter values that are common throughout the first frequency layer is different from at least one corresponding second configuration parameter value of a plurality of second configuration parameter values that are common through the second frequency layer.

Clause 21. The network entity of clause 18, wherein at least one positioning reference signal resource set is shared by the first frequency layer and the second frequency layer, or at least one positioning reference signal resource is shared by the first frequency layer and the second frequency layer, or a combination thereof.

Clause 22. The network entity of clause 18, wherein the processor is configured to indicate, to the sensing apparatus, that the first frequency layer is for radio frequency sensing and that the second frequency layer is for positioning.

Clause 23. The network entity of clause 17, wherein the positioning reference signal is a first positioning reference signal, and the processor is configured to schedule transmission of the first positioning reference signal in a time gap between scheduled transmissions of a second positioning reference signal indicated to be for positioning.

Clause 24. The network entity of clause 17, wherein the processor is configured to schedule transmission of the positioning reference signal by a base station based on a proximity of the base station to the sensing apparatus.

Clause 25. A positioning reference signal scheduling method comprising:
scheduling, by a network entity for a sensing apparatus, a positioning reference signal configuration of a positioning reference signal; and
indicating, from the network entity to the sensing apparatus, that the positioning reference signal is for radio frequency sensing.

Clause 26. The positioning reference signal scheduling method of clause 25, wherein the positioning reference signal is a first positioning reference signal, and wherein the positioning reference signal scheduling method further comprises:
scheduling, by the network entity, a first frequency layer including the first positioning reference signal;
scheduling, by the network entity for the sensing apparatus, a second frequency layer including a second positioning reference signal; and
indicating, by the network entity to the sensing apparatus, that the second positioning reference signal is for positioning.

Clause 27. The positioning reference signal scheduling method of clause 26, wherein first configuration parameter values that are common throughout the first frequency layer are identical to corresponding second configuration parameter values that are common through the second frequency layer.

Clause 28. The positioning reference signal scheduling method of clause 26, wherein at least one of a plurality of first configuration parameter values that are common throughout the first frequency layer is different from at least one corresponding second configuration parameter value of a plurality of second configuration parameter values that are common through the second frequency layer.

Clause 29. The positioning reference signal scheduling method of clause 26, wherein at least one positioning reference signal resource set is shared by the first frequency layer and the second frequency layer, or at least one positioning reference signal resource is shared by the first frequency layer and the second frequency layer, or a combination thereof.

Clause 30. The positioning reference signal scheduling method of clause 26, further comprising indicating, by the network entity to the sensing apparatus, that the first frequency layer is for radio frequency sensing and that the second frequency layer is for positioning.

Clause 31. The positioning reference signal scheduling method of clause 25, wherein the positioning reference signal is a first positioning reference signal, and the positioning reference signal scheduling method further comprises scheduling transmission of the first positioning reference signal in a time gap between scheduled transmissions of a second positioning reference signal indicated to be for positioning.

Clause 32. The positioning reference signal scheduling method of clause 25, further comprising scheduling, by the network entity, transmission of the positioning reference signal by a base station based on a proximity of the base station to the sensing apparatus.

Clause 33. A network entity comprising:
means for scheduling, for a sensing apparatus, a positioning reference signal configuration of a positioning reference signal; and
means for indicating, to the sensing apparatus, that the positioning reference signal is for radio frequency sensing.

Clause 34. The network entity of clause 33, wherein the positioning reference signal is a first positioning reference signal, and wherein the network entity further comprises:
means for scheduling a first frequency layer including the first positioning reference signal;
means for scheduling, for the sensing apparatus, a second frequency layer including a second positioning reference signal; and
means for indicating, to the sensing apparatus, that the second positioning reference signal is for positioning.

Clause 35. The network entity of clause 34, wherein first configuration parameter values that are common throughout the first frequency layer are identical to corresponding second configuration parameter values that are common through the second frequency layer.

Clause 36. The network entity of clause 34, wherein at least one of a plurality of first configuration parameter values that are common throughout the first frequency layer is different from at least one corresponding second configuration parameter value of a plurality of second configuration parameter values that are common through the second frequency layer.

Clause 37. The network entity of clause 34, wherein at least one positioning reference signal resource set is shared by the first frequency layer and the second frequency layer, or at least one positioning reference signal resource is shared by the first frequency layer and the second frequency layer, or a combination thereof.

Clause 38. The network entity of clause 34, further comprising means for indicating, to the sensing apparatus, that the first frequency layer is for radio frequency sensing and that the second frequency layer is for positioning.

Clause 39. The network entity of clause 33, wherein the positioning reference signal is a first positioning reference signal, and the network entity further comprises means for scheduling transmission of the first positioning reference signal in a time gap between scheduled transmissions of a second positioning reference signal indicated to be for positioning.

Clause 40. The network entity of clause 33, further comprising means for scheduling transmission of the positioning reference signal by a base station based on a proximity of the base station to the sensing apparatus.

Clause 41. A non-transitory, processor-readable storage medium comprising processor-readable instructions to cause a processor of a network entity to:
schedule, for a sensing apparatus, a positioning reference signal configuration of a positioning reference signal; and
indicate, to the sensing apparatus, that the positioning reference signal is for radio frequency sensing.

Clause 42. The non-transitory, processor-readable storage medium of clause 41, wherein the positioning reference signal is a first positioning reference signal, and wherein the non-transitory, processor-readable storage medium further comprises processor-readable instructions to cause the processor to:
schedule a first frequency layer including the first positioning reference signal;
schedule, for the sensing apparatus, a second frequency layer including a second positioning reference signal; and
indicate, to the sensing apparatus, that the second positioning reference signal is for positioning.

Clause 43. The non-transitory, processor-readable storage medium of clause 42, wherein first configuration parameter values that are common throughout the first frequency layer are identical to corresponding second configuration parameter values that are common through the second frequency layer.

Clause 44. The non-transitory, processor-readable storage medium of clause 42, wherein at least one of a plurality of first configuration parameter values that are common throughout the first frequency layer is different from at least one corresponding second configuration parameter value of a plurality of second configuration parameter values that are common through the second frequency layer.

Clause 45. The non-transitory, processor-readable storage medium of clause 42, wherein at least one positioning reference signal resource set is shared by the first frequency layer and the second frequency layer, or at least one positioning reference signal resource is shared by the first frequency layer and the second frequency layer, or a combination thereof.

Clause 46. The non-transitory, processor-readable storage medium of clause 42, further comprising processor-readable instructions to cause the processor to indicate, to the sensing apparatus, that the first frequency layer is for radio frequency sensing and that the second frequency layer is for positioning.

Clause 47. The non-transitory, processor-readable storage medium of clause 41, wherein the positioning reference signal is a first positioning reference signal, and the non-transitory, processor-readable storage medium further comprises processor-readable instructions to cause the processor to schedule transmission of the first positioning reference signal in a time gap between scheduled transmissions of a second positioning reference signal indicated to be for positioning.

Clause 48. The non-transitory, processor-readable storage medium of clause 41, further comprising processor-readable instructions to cause the processor to schedule transmission of the positioning reference signal by a base station based on a proximity of the base station to the sensing apparatus.

Clause 49. A radio frequency sensing method comprising:
scheduling, by a network entity, a radio frequency sensing reference signal;
transmitting, from the network entity to a sensing apparatus, reference signal measurement assistance data;
transmitting, from the network entity to the sensing apparatus, the radio frequency sensing reference signal; and
receiving, at the network entity from the sensing apparatus, a measurement report corresponding to measurement of the radio frequency sensing reference signal.

Clause 50. The radio frequency sensing method of clause 49, further comprising:
receiving, from a requesting entity, a request for radio frequency sensing; and
transmitting, from the network entity to the requesting entity, a radio frequency sensing response based on the measurement report.

Clause 51. The radio frequency sensing method of clause 50, wherein the requesting entity comprises a user equipment or a base station.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A sensing apparatus comprising:
a memory;
a transceiver; and
a processor, communicatively coupled to the memory and the transceiver, configured to:
receive, via the transceiver from a network entity, a configuration message indicating a positioning reference signal configuration of a positioning reference signal;
receive, via the transceiver from the network entity, a measurement indication indicating that the positioning reference signal is for radio frequency sensing; and
measure the positioning reference signal to determine one or more radio frequency sensing measurements based on the measurement indication indicating that the positioning reference signal is for radio frequency sensing.

2. The sensing apparatus of claim 1, wherein the processor is configured to measure, in response to the measurement indication indicating that the positioning reference signal is also for positioning, the positioning reference signal to determine one or more positioning measurements.

3. The sensing apparatus of claim 1, wherein the positioning reference signal is a first positioning reference signal, and wherein the processor is configured to:
measure at least one of the first positioning reference signal or a second positioning reference signal to determine one or more positioning measurements;
receive, via the transceiver from the network entity, a priority indication indicating a priority of the one or more radio frequency sensing measurements and the one or more positioning measurements; and
report, via the transceiver to the network entity, the one or more radio frequency sensing measurements, or the one or more positioning measurements, or a combination thereof, based on the priority of the one or more radio frequency sensing measurements and the one or more positioning measurements, and based on a reporting capability of the sensing apparatus.

4. The sensing apparatus of claim 1, wherein the measurement indication indicates that a frequency layer, corresponding to the positioning reference signal, is for radio frequency sensing.

5. A radio frequency sensing method comprising:
receiving, at a sensing apparatus from a network entity, a configuration message indicating a positioning reference signal configuration of a positioning reference signal;
receiving, at the sensing apparatus from the network entity, a measurement indication indicating that the positioning reference signal is for radio frequency sensing; and
measuring, at the sensing apparatus, the positioning reference signal to determine one or more radio frequency sensing measurements based on the measurement indication indicating that the positioning reference signal is for radio frequency sensing.

6. The radio frequency sensing method of claim 5, wherein measuring the positioning reference signal comprises measuring, in response to the measurement indication indicating that the positioning reference signal is also for positioning, the positioning reference signal to determine one or more positioning measurements.

7. The radio frequency sensing method of claim 5, wherein the positioning reference signal is a first positioning reference signal, and wherein the radio frequency sensing method further comprises:
measuring, at the sensing apparatus, at least one of the first positioning reference signal or a second positioning reference signal to determine one or more positioning measurements;
receiving, at the sensing apparatus from the network entity, a priority indication indicating a priority of the one or more radio frequency sensing measurements and the one or more positioning measurements; and
reporting, to the network entity, the one or more radio frequency sensing measurements, or the one or more positioning measurements, or a combination thereof, based on the priority of the one or more radio frequency sensing measurements and the one or more positioning measurements, and based on a reporting capability of the sensing apparatus.

8. The radio frequency sensing method of claim 5, wherein the measurement indication indicates that a frequency layer, corresponding to the positioning reference signal, is for radio frequency sensing.

9. A network entity comprising:
a memory;
a transceiver; and
a processor, communicatively coupled to the memory and the transceiver, configured to:
schedule, for a sensing apparatus, a positioning reference signal configuration of a positioning reference signal; and
indicate, to the sensing apparatus, that the positioning reference signal is for radio frequency sensing.

10. The network entity of claim 9, wherein the positioning reference signal is a first positioning reference signal, and wherein the processor is configured to:
schedule a first frequency layer including the first positioning reference signal;
schedule, for the sensing apparatus, a second frequency layer including a second positioning reference signal; and
indicate, to the sensing apparatus, that the second positioning reference signal is for positioning.

11. The network entity of claim 10, wherein first configuration parameter values that are common throughout the first frequency layer are identical to corresponding second configuration parameter values that are common through the second frequency layer.

12. The network entity of claim 10, wherein at least one of a plurality of first configuration parameter values that are common throughout the first frequency layer is different from at least one corresponding second configuration parameter value of a plurality of second configuration parameter values that are common through the second frequency layer.

13. The network entity of claim 10, wherein at least one positioning reference signal resource set is shared by the first frequency layer and the second frequency layer, or at least one positioning reference signal resource is shared by the first frequency layer and the second frequency layer, or a combination thereof.

14. The network entity of claim 10, wherein the processor is configured to indicate, to the sensing apparatus, that the first frequency layer is for radio frequency sensing and that the second frequency layer is for positioning.

15. The network entity of claim 9, wherein the positioning reference signal is a first positioning reference signal, and the processor is configured to schedule transmission of the first positioning reference signal in a time gap between scheduled transmissions of a second positioning reference signal indicated to be for positioning.

16. The network entity of claim 9, wherein the processor is configured to schedule transmission of the positioning reference signal by a base station based on a proximity of the base station to the sensing apparatus.

17. A positioning reference signal scheduling method comprising:
scheduling, by a network entity for a sensing apparatus, a positioning reference signal configuration of a positioning reference signal; and
indicating, from the network entity to the sensing apparatus, that the positioning reference signal is for radio frequency sensing.

18. The positioning reference signal scheduling method of claim 17, wherein the positioning reference signal is a first positioning reference signal, and wherein the positioning reference signal scheduling method further comprises:
scheduling, by the network entity, a first frequency layer including the first positioning reference signal;
scheduling, by the network entity for the sensing apparatus, a second frequency layer including a second positioning reference signal; and
indicating, by the network entity to the sensing apparatus, that the second positioning reference signal is for positioning.

19. The positioning reference signal scheduling method of claim 18, wherein first configuration parameter values that are common throughout the first frequency layer are identical to corresponding second configuration parameter values that are common through the second frequency layer.

20. The positioning reference signal scheduling method of claim 18, wherein at least one of a plurality of first configuration parameter values that are common throughout the first frequency layer is different from at least one corresponding second configuration parameter value of a plurality of second configuration parameter values that are common through the second frequency layer.

21. The positioning reference signal scheduling method of claim 18, wherein at least one positioning reference signal resource set is shared by the first frequency layer and the second frequency layer, or at least one positioning reference signal resource is shared by the first frequency layer and the second frequency layer, or a combination thereof.

22. The positioning reference signal scheduling method of claim 18, further comprising indicating, by the network entity to the sensing apparatus, that the first frequency layer is for radio frequency sensing and that the second frequency layer is for positioning.

23. The positioning reference signal scheduling method of claim 17, wherein the positioning reference signal is a first positioning reference signal, and the positioning reference signal scheduling method further comprises scheduling transmission of the first positioning reference signal in a time gap between scheduled transmissions of a second positioning reference signal indicated to be for positioning.

24. The positioning reference signal scheduling method of claim 17, further comprising scheduling, by the network entity, transmission of the positioning reference signal by a base station based on a proximity of the base station to the sensing apparatus.

25. A radio frequency sensing method comprising:
scheduling, by a network entity, a radio frequency sensing reference signal;
transmitting, from the network entity to a sensing apparatus, reference signal measurement assistance data;
transmitting, from the network entity to the sensing apparatus, the radio frequency sensing reference signal; and
receiving, at the network entity from the sensing apparatus, a measurement report corresponding to measurement of the radio frequency sensing reference signal.

26. The radio frequency sensing method of claim 25, further comprising:
receiving, from a requesting entity, a request for radio frequency sensing; and
transmitting, from the network entity to the requesting entity, a radio frequency sensing response based on the measurement report.

27. The radio frequency sensing method of claim 26, wherein the requesting entity comprises a user equipment or a base station.
